(19) United States
(12) Patent Application Publication
(10) Pub. No.: US 2009/0164980 A1
(43) Pub. Date: Jun. 25, 2009

(54) Cluster Application Trace

(76) Inventors: Albert Rossmann, Muhlstr (DE); Robert Heidasch, Eichendorffstr (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/963,785

(22) Filed: Dec. 21, 2007

(51) Int. Cl. G06F 9/44

(52) U.S. Cl. 717/128

(57) ABSTRACT

A system and method for tracing a clustered application are disclosed. A server system hosts the clustered application, and an instance tracer manages a shared memory segment for one or more nodes within an instance of each process of the clustered application. The instance tracer is adapted to serialize trace information for each of the one or more nodes and write the trace information directly to the shared memory segment according to a common time sequence. Preferably, the shared memory segment is arranged as a rollbuffer, and the trace information is written to the rollbuffer as a trace entry in sequential writer entries until a reader entry on the rollbuffer is reached.

### BACKGROUND

This disclosure relates generally to data processing systems, and more particularly to systems and techniques for tracing and collecting data from different locations of a data processing application.

Server-based applications are often arranged and executed in a cluster of different processes. In a J2EE instance of an application, for example, two or more nodes of the application can run in different processes. Traditionally, each process manages its own application traces, which makes it difficult to find information for a given maintenance issue. There is a high probability that entries of different traces can be correlated, but it is nearly impossible to get the right time sequence for all trace entries.

What is needed is a way to collect and trace a large amount of data from different locations of a distributed data processing application. Writing data to a central store does not scale very well, so such an arrangement will hold data locally until analyzing starts.

### SUMMARY

In general, this document discusses a system and method for cluster application traces. In one arrangement, a system includes an instance tracer, which manages a shared memory segment, called a rollbuffer, for each instance, and a cluster tracer which collects the results. Trace entries carry component and severity information to allow the appropriate tracer to reject or accept entries for a specific component or severity into a trace buffer. One special case of a trace type is called a log entry. A log entry includes information for system administration, and there is no filter to prohibit the output. The arrangement includes a mechanism to save log entries before clearing the trace buffer.

In one aspect, a system for tracing a clustered application is disclosed. The system includes a server system that hosts the clustered application, and an instance tracer that manages a shared memory segment for one or more nodes within an instance of each process of the clustered application. The instance tracer is adapted to serialize trace information for each of the one or more nodes and write the trace information directly to the shared memory segment according to a common time sequence. In preferred exemplary implementations, the shared memory segment is arranged as a rollbuffer, and the trace information is written to the rollbuffer as a trace entry in sequential writer entries until a reader entry on the rollbuffer is reached.

In another aspect, a system for tracing a clustered application is presented, in which the system includes an instance tracer that manages a shared memory segment for one or more nodes within an instance of each process of the clustered application. The instance tracer is adapted to serialize trace information for each of the one or more nodes and write the trace information directly to the shared memory segment according to a common time sequence. The system further includes a cluster tracer collector that is adapted to collect the trace information from each shared memory segment associated with each instance tracer.

In yet another aspect, a method for tracing a clustered application is disclosed. The method includes the steps of managing a shared memory segment for one or more nodes within an instance of each process of the clustered application, serializing trace information for each of the one or more nodes, and writing the trace information directly to the shared memory segment according to a common time sequence.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 shows a general layout of an exemplary rollbuffer.

FIG. 2 illustrates a layout of an exemplary buffer entry.

FIG. 3 illustrates an instance tracer.

FIG. 4 depicts a system including a cluster tracer collector.

Like reference symbols in the various drawings indicate like elements.

### DETAILED DESCRIPTION

This document describes a cluster application trace system and method, including an instance tracer, which for each instance of a distributed application manages a shared memory segment called a rollbuffer. The system and method further includes a cluster tracer which collects the results of each trace. Trace entries carry component and severity information to allow the appropriate tracer to reject or accept entries for a specific component or severity into a trace buffer. One special case of a trace type is called a log entry. A log entry includes valuable information for system administration, and there is no filter to prohibit the output. The arrangement includes a mechanism to save log entries before clearing the trace buffer.

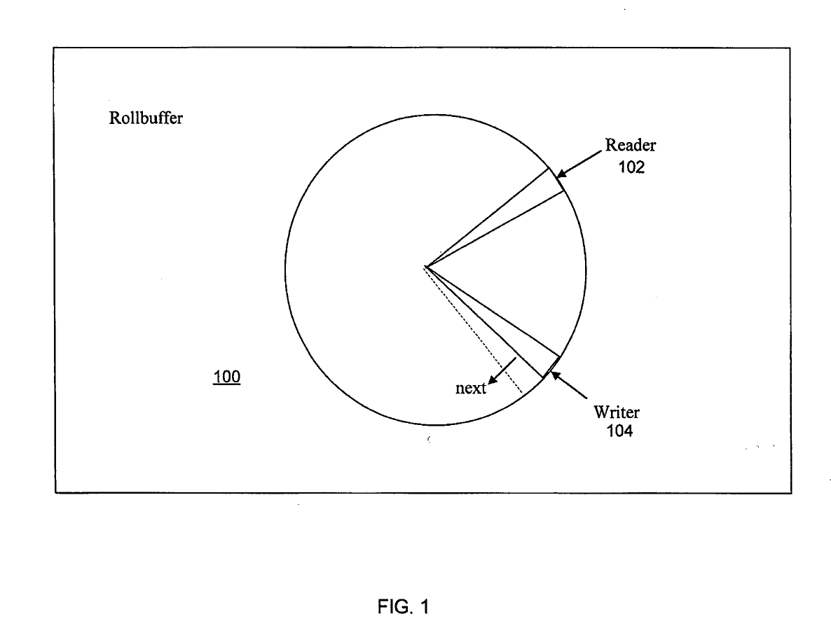

The trace information is stored in the rollbuffer. A general layout of an exemplary rollbuffer 100 is shown in FIG. 1. At first, a reader 102 occupies the same position as a writer 104. The writer 104 fills entries and steps forward clockwise. As soon as the writer 104 reaches the reader 102, having stepped completely clockwise, the reader 102 runs synchronously with the writer 102, but keeping one position ahead of the writer 104.

The rollbuffer 100 is read starting with the reader 102 position and ending at the writer 104 position. The reader 102 position steps forward clockwise while reading, until it reaches the writer 104 position. It may happen that some entries are overwritten before they are read. At this, point log information must be transferred to a persistence layer.

All entries for the rollbuffer 100 preferably occupy the same, fixed size data area, so that any entry can be reused. A fixed sized data area can also contain text elements, but these should be restricted to names and parameter values, e.g. method names or property key-value pairs. This concept works best using a text database and inserting text reference IDs into the trace, which would also enable localization of messages. This also includes text IDs for variable text elements for specific entries like stack dumps and exception traces. Any text that is related to an overwritten entry is deleted.

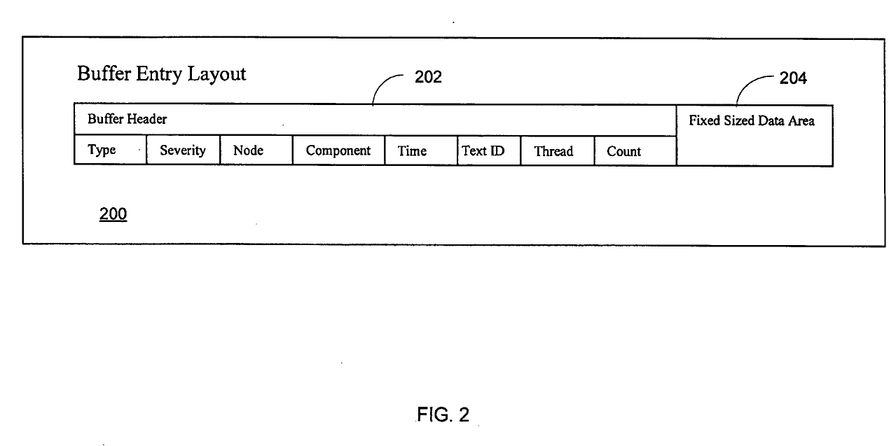

FIG. 2 illustrates a layout of an exemplary buffer entry 200. The buffer entry 200 contains a header 202 that can include information such as type, severity, node, component, timestamp, and text ID. The header 202 can also include components such as thread number and counter. The counter can be used to count up the number of subsequent entries of the same type, so that a trace output in an endless loop will not destroy the whole buffer. The buffer entry 200 further includes a fixed size data area 204, which is filled depending on the type in the header.

Information for the data area in FIG. 2 relates to the type as follows:

| Buffer Header Type | Fixed Size Data Area |
|---|---|
| Protocol | GUID, Client, Send/Receive, Thread, Data-Text-ID, |
| | Buffer-Len |
| Method | Method-ID, source file name, line number, |
| | statistical data like CPU consumption |
| Dump-GC | Memory, Objects, Statistics |
| Dump-Attribute | Method-ID, attribute name, attribute value |
| Dump-Thread | Dump-ID |
| Dump-Data | Access, Data-Text-ID |
| Log | Text |
| Trace | Text |

One advantage of this arrangement is that confidential data such as passwords can be hidden, and would be available only for granted access. The data text ID is created for an arbitrary string and can be used to later check for the same string. With sufficient rights, the direct access to secure data is possible.

Different nodes can be traced according to a different sequence and a different severity. The trace collector directs all traces to their proper sequence, and applies a filter to resolve text from the database. Finally, the output is formatted to save CPU resources and disk capacity. It is easy to collect and send data for support. An output formatter is assigned to the entry header type. This ensures a uniqueness for all traces and the ability to localize text elements.

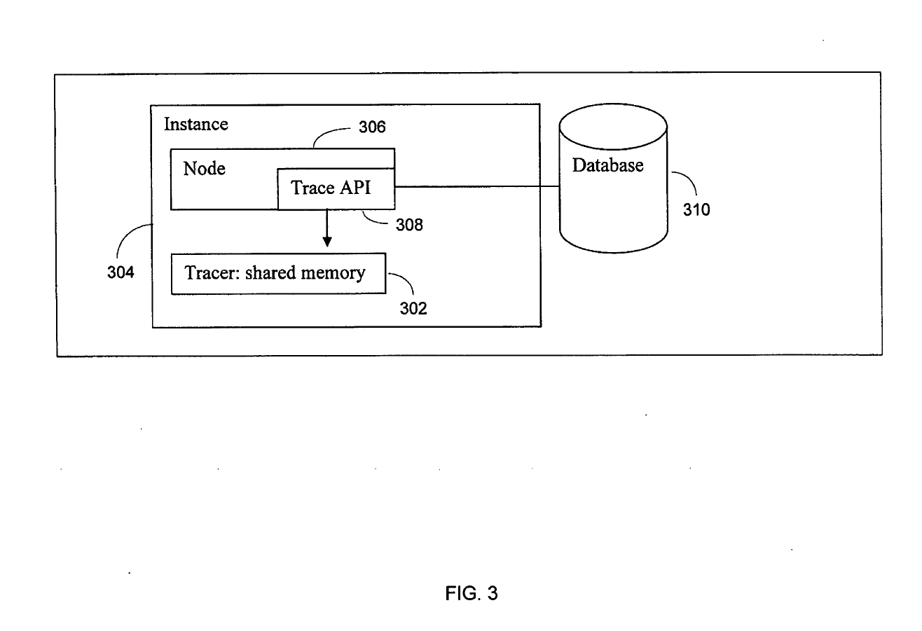

As illustrated in FIG. 3, an instance tracer 302 runs in its own process for a J2EE instance 304. The instance tracer 302 shares a memory segment for trace output and serializes trace information of different nodes 306 via local trace API 308. The nodes 306 write directly to the shared memory 302, so that the correct time sequence is kept and there is no overhead in protocol communication. The rollbuffer architecture ensures that, even for high trace traffic, the shared memory segment disc will not suffer an overflow. The maximum buffer segment size is fixed and can be set at the start of the instance.

The shared memory segment is lost if the instance 304 is stopped and the instance tracer 302 terminates. At this point an administrator must decide whether to save the traces and log entries. The instance tracer 302 maintains the components, the severity for each node and a semaphore, which is needed to write trace records. A database 310 is used to maintain the component hierarchy to enable the activation of subcomponents.

The local trace API 308 is adapted to collect trace entries into a thread local buffer, and to later send the result to the shared memory. The local thread buffer is provided to the shared memory if either the trace has defined entry and exit points or a clock signals a timeout.

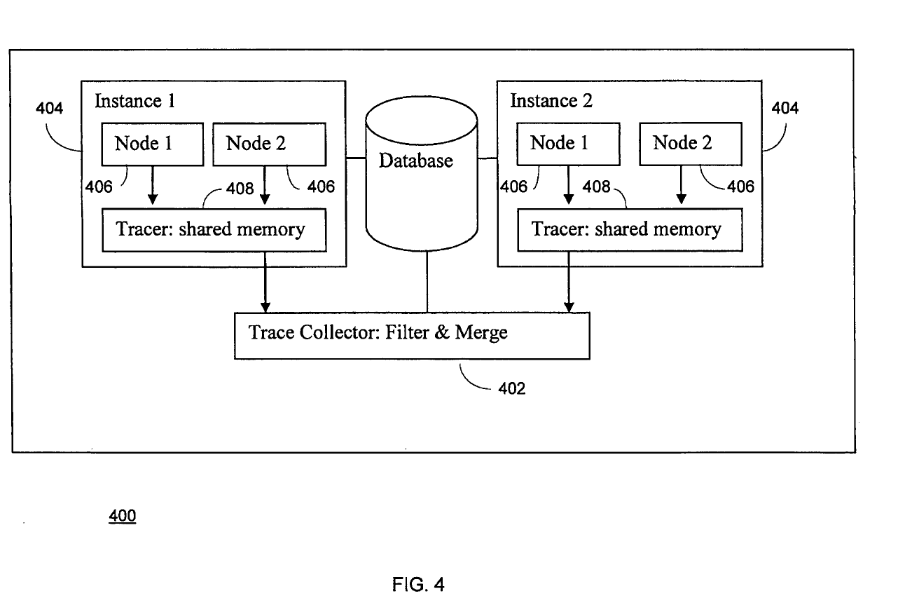

FIG. 4 depicts a system 400 including a cluster tracer collector 402. On request the cluster tracer collector 402 is able to collect the trace information of several instances 404 and nodes 406. It is able to filter for a certain component, node or protocol. There is no need for the maintenance to search for a consistent set of trace files.

The cluster tracer collector 402 is able to merge the different shared memory segments 408 in the right time sequence using timestamp information from the header, as described above. For protocol traces the cluster tracer collector 402 uses the GUID in the data area to find matching send and receive events. A global text management function generates a hash for the transferred data as a text buffer ID, so that it is not necessary to dump the buffer for protocol transfer more than once for the same text buffer ID.

The tracer interface allows hard coded trace and log outputs, as exemplified as follows:

Trace.Open( )
Trace.Close( )
Trace.Write( Trace Structure )
Trace.Write( Type, ... )

In a Java implementation, it is possible to use an agent for flexible instrumentation. In this case the user can activate traces for methods and parameters during runtime. This is most efficient, because there are no unused statements in case the trace is switched off. The idea is to modify byte code or use “Profile Points” to generate trace output using the Java Native Interface (JNI).

The tracer allows specifying a component, which can be set for an application or a specific thread. The component is stored in the text database and must be unique:

Trace.SetComponent(String)

The system layer inserts the thread ID and the timestamp to each record. It also checks whether the user tries to insert the same record sequentially and increases the counter instead of rewriting the same record.

The trace collector writes the result into a local storage. The search structure may contain regular expressions for each entry.

ResultSet=TraceCollector.Analyse(ResultSet, SearchStructure)

The search structure contains the hosts, instances, the nodes and timestamp intervals that are used for analysis. The data structures are kept so that a search can be relaunched at a given result set. A new analysis is started if ResultSet is null. The number of records within a result set is returned by the following call:

Number of Records=TraceCollector.Count(ResultSet)

The formatted output is triggered by the following command:

TraceCollector.Write(Output File, ResultSet)

The unformatted result set can be dumped and read with the following command for maintenance:

TraceCollector.Dump( Output File, ResultSet )
TraceCollector.Read( Input File )

Merging traces from different instances makes sense only if there was a communication between the different instances. Thus, this merge is restricted on traces, which are enclosed by protocol events.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A system for tracing a clustered application, the system comprising:
a server system that hosts the clustered application; and
an instance tracer that manages a shared memory segment for one or more nodes within an instance of each process of the clustered application, the instance tracer being adapted to serialize trace information for each of the one or more nodes and write the trace information directly to the shared memory segment according to a common time sequence.

2. The system according to claim 1, further comprising a cluster tracer collector that is adapted to collect the trace information from each shared memory segment associated with each instance tracer.

3. The system according to claim 2, wherein the cluster tracer collector is further adapted to merge the trace information from each shared memory segment according to the common time sequence.

4. The system according to claim 1, wherein the shared memory segment is arranged as a rollbuffer, and wherein the trace information is written to the rollbuffer as a trace entry in sequential writer entries until a reader entry on the rollbuffer is reached.

5. The system according to claim 4, wherein each trace entry occupies the same memory area in the shared memory segment.

6. The system according to claim 4, wherein each trace entry includes component information and severity information associated with a trace of each node.

7. The system according to claim 4, wherein at least one trace entry includes a log entry that includes information for administration of the system.

8. A system for tracing a clustered application, the system comprising:
an instance tracer that manages a shared memory segment for one or more nodes within an instance of each process of the clustered application, the instance tracer adapted to serialize trace information for each of the one or more nodes and write the trace information directly to the shared memory segment according to a common time sequence; and
a cluster tracer collector that is adapted to collect the trace information from each shared memory segment associated with each instance tracer.

9. The system according to claim 8, wherein the cluster tracer collector is further adapted to merge the trace information from each shared memory segment according to the common time sequence.

10. The system according to claim 8, wherein the shared memory segment is arranged as a rollbuffer, and wherein the trace information is written to the rollbuffer as a trace entry in sequential writer entries until a reader entry on the rollbuffer is reached.

11. The system according to claim 10, wherein each trace entry occupies the same memory area in the shared memory segment.

12. The system according to claim 10, wherein each trace entry includes component information and severity information associated with a trace of each node.

13. The system according to claim 10, wherein at least one trace entry includes a log entry that includes information for administration of the system.

14. A method for tracing a clustered application, the method comprising:
managing a shared memory segment for one or more nodes within an instance of each process of the clustered application;
serializing trace information for each of the one or more nodes; and
writing the trace information directly to the shared memory segment according to a common time sequence.

15. The method according to claim 14, further comprising collecting the trace information from each shared memory segment associated with each instance tracer.

16. The method according to claim 15, further comprising merging the trace information from each shared memory segment according to the common time sequence.

17. The method according to claim 8, wherein the shared memory segment is arranged as a rollbuffer, and wherein the trace information is written to the rollbuffer as a trace entry in sequential writer entries until a reader entry on the rollbuffer is reached.

18. The method according to claim 17, wherein each trace entry occupies the same memory area in the shared memory segment.

19. The method according to claim 17, wherein each trace entry includes component information and severity information associated with a trace of each node.

20. The method according to claim 17, wherein at least one trace entry includes a log entry that includes information for administration of the system.
